(19) United States
(12) Patent Application Publication
(10) Pub. No.: US 2015/0152722 A1
(43) Pub. Date: Jun. 4, 2015

(54) SYSTEM AND METHOD FOR REALIZING ADDED VALUE FROM PRODUCTION GAS STREAMS IN A CARBON DIOXIDE FLOODED EOR OILFIELD

(71) Applicant: Paul Andrew Carmody, Spring, TX (US)

(72) Inventor: Paul Andrew Carmody, Spring, TX (US)

(21) Appl. No.: 14/093,314

(22) Filed: Nov. 29, 2013

(51) Int. Cl. E21B 43/40; B01D 19/00

(52) U.S. Cl. CPC E21B 43/40; B01D 19/0031

(57) ABSTRACT

A system and method for realizing added value from the production gas stream exiting wells in a Carbon Dioxide Flooded EOR oilfield includes a Membrane Bulk Cut Facility for separating the production gas stream into an Enriched Carbon Dioxide Stream and an Enriched Hydrocarbon Stream. The Enriched Hydrocarbon Stream is transported to a Bulk Cut Gathering System for combination with the production gas stream from other oilfields. The output of the Bulk Cut Gathering System is transported to a Bulk Cut Processing Plant for further separation of the carbon dioxide gas and transformation of the Enriched Hydrocarbon Streams in added revenue for the operators of the wells and reservoirs in a Carbon Dioxide Flooded EOR oilfield.

### CROSS REFERENCE TO RELATED APPLICATIONS

The present Non-Provisional U.S. patent application claims priority from Provisional U.S. Patent Application No. 61/731,012 filed Nov. 29, 2012.

### STATEMENT REGARDING FEDERALLY SPONSORED RESEARCH OR DEVELOPMENT

The invention described in this Non-Provisional U.S. patent application was not the subject of federally sponsored research or development.

### BACKGROUND

1. Field of the Invention

The present invention pertains to a system and method for realizing added value from a production gas stream; more particularly, the present invention pertains to a system and method for treating a production gas stream exiting a well located in Carbon Dioxide flooded Enhanced Oil Recovery (EOR)oilfields where the underground formation is flooded with carbon dioxide gas to increase the production of natural gas and natural gas liquids from the underground formation in which the crude oil is located.

2. Related Prior Art

The growing number of Carbon Dioxide Flooded EOR oilfields both in the United States and around the world is an indication of the viability of the carbon dioxide flooding technique for increasing the amount of crude oil produced from the reserves in the underground formation in oilfields. Carbon Dioxide Flooded EOR oilfields are created by the injection of carbon dioxide gas into underground formations containing one or more reservoirs of crude oil. This process of flooding an underground formation with carbon dioxide gas to cause more crude oil to come out of wells is known as Carbon Dioxide Flooded Enhanced Oil Recovery (EOR). The carbon dioxide gas mixes with the fluids, both liquid and gas, contained in the reservoirs within the underground formation to mobilize the liquid crude oil for extraction through the holes or wells bored through the earth's surface to gain access to underground reservoirs. It is through these well bores that oil, gas and water come back up to the earth's surface. The production gas, the liquid crude oil, and the water come out of the well bore as a multi-phase mixture.

As the Carbon Dioxide Flooded EOR oilfield business was developed during the 1970's and 1980's, the technology used in non-EOR oilfields was adapted to the Carbon Dioxide Flooded oilfields. Specifically, the idea was that gas from non-EOR oilfields would be gathered and sent to a central gas processing plant for processing into valuable natural gas and natural gas liquid products. Despite the adaptation of non-EOR oilfields only a very small number proved to be successful. While the new systems adapted for use with non-EOR fields successfully dealt with the higher pressures, the special physical properties of the fluids exiting the wells, and the higher corrosion rates associated with the use of carbon dioxide gas, the problem of effectively and economically gathering and processing the production gas from these floods was not solved.

Currently, operators, must decide, on an oilfield-by-oilfield basis, to either perform only reinjection or put in place complex and expensive gas plant plants for realizing value from the production gas exiting the wells. Those operators choosing reinjection sacrifice all economic benefit from natural gas and natural gas liquid recoveries. Effectively, the operators must choose between too little processing or too much processing as there as there has been no way of selecting a just right processing alternative for effectively and economically transporting gas to a central plant for recovering its value.

Understanding the need for a just right processing alternative for enabling the processing of gas from numerous oilfields at one or more central gas processing plants is key to the understanding of the disclosed invention.

Operators understand that after the continued operation of a well and the continued reinjection of the production gas stream back into the formation to maintain the Carbon Dioxide EOR flood, the concentration of carbon dioxide in the production gas stream increases. The increase is in the concentration of carbon dioxide in the production gas stream is rapid and often, after about two years of Carbon Dioxide Flooded EOR, which involves injecting fresh carbon dioxide from outside the oilfield plus reinjecting the bulk of the production gas stream back into the underground formation, carbon dioxide becomes the main constituent in the production gas stream. Ultimately, the carbon dioxide concentration in the production gas stream may exceed 95% (mole percent used unless otherwise indicated) during the remaining production life of an oil well producing crude oil from a Carbon Dioxide Flooded EOR oilfield. Such remaining production life of an individual well in a Carbon Dioxide Flooded EOR oilfield can be 50 years or greater.

In addition to carbon dioxide gas being part of the production gas stream, the production gas stream may include some valuable other gases that have not been absorbed by the produced crude oil. Such other gases, such as methane or ethane, may have value individually. Such gases may also have value in that they can be transformed into other products at a gas processing plant or refinery.

In addition to the liquid crude oil, other liquids characterized as natural gas liquids also come out of individual wells. The majority of these liquids reside in the produced gas from the well. Such natural gas liquids may also have value in that they can be chemically transformed into products which have the potential to return value to the well operator. Such natural gas liquids may represent greater than 15% of the crude oil product coming out of an individual well (on a volume basis).

Although highly desirable, the separation of the carbon dioxide gas stream from the production gas stream has proven to be a difficult problem in practice.

Some well operators have relied on remote complex gas processing plants to recover the carbon dioxide and the hydrocarbons having commercial value from the streams of production gas. Those complex gas processing plants that have the capacity to recover carbon dioxide, gaseous hydrocarbons and natural gas liquids are costly to build and operate.

As a consequence of the expense of building a complex gas processing plant, some simpler and less expensive gas processing plants that have the capability to recover only natural gas liquids and no gaseous hydrocarbons have been built near some oilfields. But, even these simpler and less expensive gas processing plants generally do not pay for themselves unless they are located near reservoirs known for capable of producing large amounts of natural gas liquids. Accordingly, in many cases, only gas compression and gas dehydration facilities have been used near some oilfields to reinject the entire production gas stream back into the underground formation. In these cases, the operators of the individual oil wells forego any opportunity to recover any of the value from the hydrocarbons contained in the stream of production gas.

In some individual cases there have been efforts to move the production gas stream from an oil well to a gas processing plant which gas processing plant is typically located at a great distance from the individual oil well by constructing a transport pipeline system. In such cases the transport pipeline pressure is less than about 740 psi. This about 740 psi transport pipeline pressure necessitates the use of large diameter pipelines as the entire volume of production gas from multiple individual oil wells is transported through the transport pipeline to the gas processing plant at a relatively low density. Moreover, the use of transport pipeline for a gas transport system is typically a two-phase system; that is, the transported mixture of gases and liquids is transported in two phases, each phase being in equilibrium with one another. Accordingly, it is not unusual for slugs of liquid hydrocarbons to appear within the transport pipeline. Such slugs of liquid hydrocarbons must be rejected at the inlet to the gas processing plant to facilitate the separation of the gaseous portion of the contents of the transport pipeline from the liquid portion of the contents of the transport pipeline.

Gas processing plants receiving the production gas stream from the individual wells producing crude oil from the reservoirs in an oilfield have an additional problem. In order to process the production gas stream into both valuable hydrocarbon gases and into Enriched Carbon Dioxide gas, the carbon dioxide gas must be either exchanged for additional carbon dioxide gas at the gas processing plant or sent back to the oilfield where it originated for reinjection back into the underground formation. Such return of the carbon dioxide gas from remote gas processing plants requires compression of the carbon dioxide gas at the gas processing plant and the construction and maintenance of a dense phase carbon dioxide gas return pipeline between the gas processing plant and the individual well in the oilfield.

Accordingly, a need remains in the art for enabling separating out the carbon dioxide gas from the production gas stream. Once separated, the carbon dioxide gas should be made ready for reinjection back into the underground formation with minimal movement of the carbon dioxide gas. At the same time the transport of the Enriched Hydrocarbon Stream of the production gas stream to a gas processing facility should be enabled for chemical transformation into products providing value to the operators of the individual wells.

### SUMMARY

The present invention provides a system and method for enabling separating out the carbon dioxide gas from the production gas stream. Once separated, the Enriched Carbon Dioxide Stream is made ready for reinjection back into the underground formation with minimal movement of the carbon dioxide gas. At the same time the transport of the hydrocarbon rich portion of the production gas stream to a gas processing facility is enabled where it can be chemically transformed into products providing added value to the operators of individual wells.

The system and method of the present invention includes several main components, as follows:

1) A Membrane Bulk Cut Facility

2) A Bulk Cut Gathering System, and

3) A Bulk Cut Processing Plant

At least one Membrane Bulk Cut Facility is located near the reservoir(s) in an oilfield. At the Membrane Bulk Cut Facility the production gas stream including both carbon dioxide gas and hydrocarbon rich gas along with natural gas liquids is pretreated removing water, heavier natural gas liquids (the most important components to remove are C6+ and aromatics), and particulate matter as such substances would damage the membranes. The temperature and pressure of the production gas stream is adjusted to levels at which the carbon dioxide gas can be removed from the production gas stream using reverse osmosis membranes. These reverse osmosis membranes enable the separation of carbon dioxide gas molecules from the other molecules in the product gas stream.

The streams created are: i) the membrane permeate stream which is the Enriched Carbon Dioxide Stream, ii) a liquid hydrocarbon rich stream from the pretreatment which is the Enriched Heavy Hydrocarbon Stream, and iii) the non-permeate stream (which may be single phase gas or gas and liquid phases) also rich in hydrocarbons, which is the Enriched Light Hydrocarbon Stream. Typically, the Enriched Heavy Hydrocarbon Stream and the Enriched Light Hydrocarbon Stream will commingle in a separator and the vapor that exits the separator will be the Enriched Light Hydrocarbon Stream and the liquid will be the Enriched Heavy Hydrocarbon Stream. The combined Enriched Heavy Hydrocarbon Stream and Enriched Light Hydrocarbon Stream is referred to as the Enriched Hydrocarbon Stream. A simulation that may approximate actual performance of a Membrane Bulk Cut Facility reveals that for a 90% carbon dioxide production gas inlet stream with a recovery of 91% carbon dioxide to the Enriched Carbon Dioxide Stream and 89% of the hydrocarbons to the Enriched Hydrocarbon Stream, the total volume of the Enriched Carbon Dioxide Stream is about 84% of the total inlet and Enriched Hydrocarbon Stream is about 16% of the total. The Enriched Hydrocarbon Stream is still about 52% carbon dioxide even after passing through the membranes.

The separated and now Enriched Carbon Dioxide Stream is first compressed to a dense phase and second sent to a Carbon Dioxide Distribution and Injection System for reinjection back into the oilfield. Note that the Carbon Dioxide Distribution and Injection System will also accept fresh carbon dioxide from sources beyond reinjection gas order to maintain and expand the operation of the Carbon Dioxide Flooded EOR oilfield. As the Membrane Bulk Cut Facility is located near the oilfield for reinjection, about 84% of all produced gas is locally reinjected minimizing the distance that most of the gas moves in transport pipelines thereby reducing pipeline size, pipeline length, and the compression required to move carbon dioxide to a potentially distant plant for processing. In this respect the Carbon Dioxide Distribution and Injection System would be substantially the same size as the prior art reinjection system for full reinjection of the production gas. In this instance, however, the majority of hydrocarbons have been separated out for the purpose of transforming them into valuable hydrocarbon products.

The Enriched Hydrocarbon Stream is preferably transformed into a dense phase for movement through a transport pipeline to a Bulk Cut Gathering System through the use of compression and pumping. In addition, the carbon dioxide content of the Enriched Hydrocarbon Stream may be adjusted to a mixture that is optimally suitable for further chemical transformation at the Bulk Cut Processing Plant. This may be accomplished by adding more membranes or by increasing the pressure drop across the membranes to reduce the percentage of carbon dioxide in the Enriched Hydrocarbon Stream. Conversely, removing membranes and reducing the pressure drop across the membranes allows more carbon dioxide to remain in the Enriched Hydrocarbon Stream.

At the Bulk Cut Gathering System, the Enriched Hydrocarbon Stream from one or more Membrane Bulk Cut Facilities come together for further transport to a Bulk Cut Processing Plant. Using the earlier simulation as the basis, the Enriched Hydrocarbon Stream is only 16% of the production gas flow rate and the gathering system can be a much smaller in size than a prior art system that would flow the full production gas flow. Dense phase increases the density from about 9.6 #/cuft (740 psig at 67 deg F) to about 36 #/cuft at (2000 psig at 67 deg F). The total actual volume reduction can be about 96% compared to the prior art of concept of gathering a full stream of production gas for processing at 740 psig. Where a 20 inch pipeline might have been needed a six inch line would be sufficient here. And, the stream would be dense phase thereby avoiding the formation of slugs.

At the Bulk Cut Processing Plant that portion of the production stream which has been separated from the carbon dioxide gas is chemically transformed into product which can provide value back to the individual well operator. As indicated above, the chemical composition of the Enriched Hydrocarbon Stream received at the Bulk Cut Processing Plant can be adjusted at the Membrane Bulk Cut Facility to whatever chemical competition is best suited for the distillation and processing equipment located at the Bulk Cut Processing Plant.

Some carbon dioxide gas will remain in the Enriched Hydrocarbon Stream received at the Bulk Cut Processing Plant. Such carbon dioxide gas may be sold or reinjected into the formation from which it originated or into another underground formation. The Bulk Cut Processing Plant will transform the hydrocarbon constituents into valuable natural gas and natural gas liquids. In addition, other products such as hydrogen sulfide gas may be recovered from the Enriched Hydrocarbon Stream transported to the Bulk Cut Processing Plant.

### BRIEF DESCRIPTION OF THE DRAWING FIGURES

A better understanding of the system and method of the present invention may be had by reference to the drawing figures wherein:

FIG. 1 is a block diagram of a macro flow chart of the preferred embodiment of the system and method of the present invention;

FIG. 2 is flow chart showing an exemplary set of hardware used in the Membrane Bulk Cut Facility of the system and method of the present invention;

FIG. 3 is a flow chart of the second embodiment of the system and method of the present invention showing an expanded range of obtaining value made possible by the present invention;

FIG. 4 is flow chart of a third embodiment of the present invention configured and assembled to operate as a stand-alone plant;

FIG. 5 is a flow chart of a two-phase low pressure fourth embodiment of the present invention;

FIG. 6 is a flow chart of a fifth embodiment of the present invention showing the use of the system and method of the present invention with transport pipelines for both Enriched Heavy Hydrocarbon Stream liquids and Enriched Light Hydrocarbon Stream gas from the Membrane Bulk Cut Facility; and

FIG. 7 is a flow chart of the sixth embodiment of the present invention showing the use of multiple Membrane Bulk Cut Facilities together with Bulk Cut Processing Plant.

FIG. 8 is flow chart of the seventh embodiment of the present invention showing the use of multiple types of Bulk Cut Gathering System pipelines feeding into a Bulk Cut Processing Plant.

### DESCRIPTION OF THE EMBODIMENTS

A still better understanding of the system and method of the present invention may be had by an understanding of the following terms which are used repeatedly in the following description of the construction and operation of the disclosed invention.

Terminology

Membrane Bulk Cut Facility. The Membrane Bulk Cut Facility accomplishes the separation of a production gas stream from one or more individual wells in a Carbon Dioxide Flooded EOR oilfield. The separation of the production gas stream is into an Enriched Carbon Dioxide Stream for reinjection back into the underground formation and into an Enriched Hydrocarbon Stream. In addition to separating the production gas stream into two streams, the production gas stream and the liquids associated therewith are dehydrated. Compression of both the Enriched Carbon Dioxide Stream and the Enriched Hydrocarbon Stream to facilitate reinjection of the Enriched Carbon Dioxide Stream into the underground formation and facilitates transport of the Enriched Hydrocarbon Stream to the Bulk Gas Gathering System.

A Carbon Dioxide Distribution and Injection System located near the Membrane Bulk Cut Facility controls the flow of the Enriched Carbon Dioxide Stream back into the oil well.

As the common descriptor “Bulk Cut” implies, the separation of the Enriched Carbon Dioxide Stream and the Enriched Hydrocarbon Stream is not the final or complete separation of the constituent parts made on the production gas stream. Rather, the Enriched Hydrocarbon Stream that is gathered and transported to the Bulk Cut Gathering System and further on to the Bulk Cut Processing Plant can be further processed as the Enriched Hydrocarbon Stream includes a majority of the valuable hydrocarbon constituents. It is also expected that after the Enriched Carbon Dioxide Stream has been separated from the production gas stream, that the Enriched Hydrocarbon Stream may still contain more than 50% carbon dioxide gas.

In those individual wells where natural gas liquids come out of the reservoir the Membrane Bulk Cut Facility may include equipment enabling the production of two hydrocarbon gas streams. Such equipment is well known to those of ordinary skill in the art. One stream is the Enriched Heavy Hydrocarbon Stream, which would include heavier natural gas liquids (the most important components to remove are C6+ and aromatics) and the other stream, which is Enriched Light Hydrocarbon Stream, would include the light hydrocarbons. With stabilization to remove carbon dioxide, the Enriched Heavy Hydrocarbon Stream could be moved into tanker trucks or into railroad tanker cars. Preferably, the heavier stream could be sent to a transport pipeline for transport to the Bulk Cut Gathering System.

Carbon Dioxide Distribution and Injection System. A Carbon Dioxide Distribution and Injection System is necessary in all Carbon Dioxide floods of EOR oilfields. Herein the Enriched Carbon Dioxide Stream is sourced from the Membrane Bulk Cut Facility rather than the prior art method of reinjection of the entire production gas stream back into the underground formation at the well site or from a downstream, remotely located gas processing plant.

Bulk Cut Gathering System. The Bulk Cut Gathering System receives and conveys the Enriched Hydrocarbon Stream from one or more Membrane Bulk Cut Facilities. The Bulk Cut Gathering System may also receive production gas from other sources thereby enabling delivery of a combined gas stream to the Bulk Cut Processing Plant. Within the Bulk Cut Gathering system are the necessary pipelines, pipe joint connections and junctions, compressors, pumps, pig launchers, pig receivers and other equipment common to transport pipeline systems used in the transportation of the Enriched Hydrocarbon Stream as either a two-phase gaseous and liquid material or preferably in the dense phase.

Bulk Cut Processing Plant. The Bulk Cut Processing Plant receives the gaseous and liquid fluids from the Bulk Cut Gathering System and chemically processes them to create products which return value to the well operator. Such products may include natural gas, natural gas liquids and sulfur. In all cases, the Bulk Cut Processing Plant will recover and compress carbon dioxide for reinjection into Carbon Dioxide Flooded EOR oilfields. A stand-alone plant would be designed such that it would handle the percentage of carbon dioxide, natural gas, gas liquids, and sulfur, as the typical Membrane Bulk Cut Facility would deliver to it. The design process could be an iterative process to discover the optimal carbon dioxide split at the Membrane Bulk Cut Facilities to generate the optimal system of, Membrane Bulk Cut Facilities, Bulk Cut Gathering System, and Bulk Cut Processing Plant.

A prior art processing plant which chemically process the production gas coming out of wells in Carbon Dioxide Flooded EOR oilfields can be readily adapted to the Enriched Hydrocarbon Stream from the Bulk Cut Gathering System. As the majority of the carbon dioxide has been already removed from the stream transported to the Bulk Cut Processing Plant, a prior art gas processing plant can be upgraded by augmenting the natural gas and natural gas liquids portions of the gas processing plant. The modified gas processing plant thus has its capacity dramatically increased, possibly more than about 500% without increasing the amount of gas compression required. Essentially, the adapted plant's flow would remain about the same flow as before being adapted but with a lower percentage of carbon dioxide and a correspondingly higher percentage of hydrocarbons than before being changed.

Although the carbon dioxide content of the Enriched Hydrocarbon Stream has been dramatically reduced, it is still much higher than a prior art gas processing plant designed to handle the typical gas from non-Carbon Dioxide Flooded EOR oilfields. Such gas processing plants typically are limited to less than about 10% carbon dioxide concentration in the feed stream. These prior art gas processing plants can be adapted for this service by augmenting their carbon dioxide removal capacity. This augmentation of prior art gas processing plants can be achieved through adding membranes, adding specialized extractive distillation (commonly referred to as the Ryan/Holmes process), or by substantially upgrading the amine system, typically using tertiary amines. After upgrading a prior art gas processing plant, this upgraded type of gas processing plant would also have added carbon dioxide recovery for reinjection into Carbon Dioxide Flooded EOR oilfields. For this type of plant, the adapted plant's flow would remain about the same flow as before but with a higher percentage of carbon dioxide and a correspondingly lower percentage of hydrocarbons than before being changed.

General Construction Design

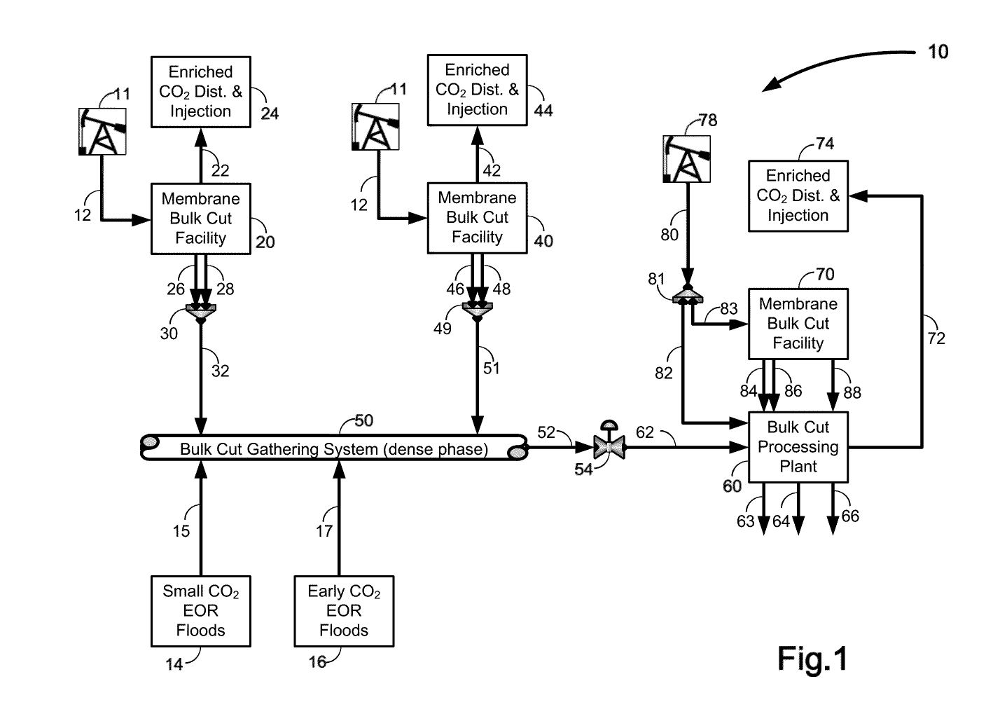

A macro overview of the preferred embodiment of the system and method 10 of the present invention including the major components described above appears in FIG. 1. Therein it may be seen that the production gas stream 12 from one or more individual wells 11 in the Carbon Dioxide Flooded EOR oilfield has been separated from the oil and from water coming out of the well 11 which represents all producing wells and production facilities which are well known in the art. The production stream gas stream 12 enters the first Membrane Bulk Cut Facility 20 which generates a dense phase Enriched Carbon Dioxide Stream 22, a dense Enriched Heavy Hydrocarbon Stream 26 and a dense phase Enriched Light Hydrocarbon Stream 28. Enriched Heavy Hydrocarbon Stream 26 and Enriched Light Hydrocarbon Stream 28 are combined at tee joint 30 before being transported to the Bulk Cut Gathering System 50 as the Enriched Hydrocarbon Stream 32.

The Enriched Carbon Dioxide Stream 22 enters the enriched Carbon Dioxide Distribution and Injection System 24. The Enriched Carbon Dioxide distribution and injection System 24 controls and distributes to the Enriched Carbon Dioxide gas to various injector wells and into the underground formation. The system 24 may also accept fresh carbon dioxide from other sources for injection back into the underground formation.

As shown in FIG. 1, a second Membrane Bulk Cut Facility 40 is shown in the preferred embodiment. Herein the dense phase Enriched Carbon Dioxide Stream 42 is sent to the Carbon Dioxide Distribution and Injection System 44. The dense phase Enriched Heavy Hydrocarbon Stream 46 and dense Enriched Light Hydrocarbon Stream 48 are combined at tee joint 49 into an Enriched Hydrocarbon Stream 51 which is transported to the Bulk Cut Gathering System 50. Other Membrane Bulk Cut Facilities may be added as needed.

At the bottom of FIG. 1 it will be noted that in addition to the output of the first Membrane Bulk Cut Facility 20 and the output of the second Membrane Bulk Cut Facility 40 additional gases maybe transported to the Bulk Cut Gathering System 50. Such additional gases may come from one or more small Carbon Dioxide Flooded EOR oilfields 14 which are transported 15 to the Bulk Gas Gathering System 50 and early stage Carbon Dioxide Flooded EOR oilfields 16 which are transported 17 to the Bulk Gas Gathering system 50. The production gas produced by a small Carbon Dioxide Flooded EOR oilfields 14 will, in most cases have a higher carbon dioxide content than the carbon dioxide content of the Enriched Hydrocarbon Streams 32 and 51. But because the total quantity of gas delivered is relatively small, this higher hydrocarbon content can be easily tolerated. This toleration of higher hydrocarbon content can be enhanced if one or both of the Membrane Bulk Cut Facilities 20, and 40, have their performance adjusted through additional membranes to offset the added carbon dioxide from the full production stream from a small Carbon Dioxide Flooded EOR field 14. Early stage Carbon Dioxide Flooded EOR oilfields 16, typically have lower flow rates and lower carbon dioxide content than fully developed floods so their production gas can be accepted. As the impact of small Carbon Dioxide Flooded EOR oilfields 14 and early stage Carbon Dioxide Flooded EOR oilfields 16 is modest and can be mitigated through operational changes to Membrane Bulk Cut Facilities the term Enriched Hydrocarbon Stream will also include these sources of gas.

The Bulk Cut Gathering System 50 conveys the fluids passing there through to an outlet stream 52. The outlet stream 52 exiting the Bulk Cut Gathering System 50 is conveyed to the Bulk Cut Processing Plant 60 in an inlet stream 62. The back pressure maintenance valve 54 assures that the entirety of the Bulk Cut Gathering System remains in dense phase.

Valve 54 is located at the inlet of the Bulk Cut Processing Plant 60. The pressure drop across the valve 54 generates useful refrigeration that the plant 60 can take advantage of. Even without precooling stream 52 from the Bulk Cut Gathering System a temperature of about zero degrees F. may be achieved in stream 62 downstream from valve 54 and since this is a dehydrated stream, hydrates will not form. If necessary, a heat exchanger (not shown) could be added to stream 52 to allow stream 62 to achieve even colder temperatures.

The Enriched Hydrocarbon Stream 62 exiting the back pressure maintenance valve 54 is conveyed to the Bulk Cut Processing Plant 60. The Bulk Cut Processing Plant 60 processes the input stream 62 and generates a variety of products to include natural gas 63, natural gas liquids 64 and sulfur 66 if hydrogen sulfide is present in the input stream 62. Any remaining Enriched Carbon Dioxide gas 72 may be reinjected into a formation located near the Bulk Cut Processing Plant 60 at a Carbon dioxide distribution and reinjection facility 74.

The Bulk Cut Processing Plant 60 is a retrofitted prior art processing plant with upgraded natural gas and natural gas liquids capacity. As such it has a Carbon Dioxide Flooded EOR oilfield associated with it as shown by well 78 which represents the wells and production facilities in the field.

It has been assumed that the prior art gas processing plant was operating at capacity so in addition to upgrading the Bulk Cut Processing Plant's 60 natural gas and natural gas liquids capacity a new Membrane Bulk Cut Facility 70 would be added to reduce the amount of carbon dioxide to be processed at the plant 60. Membrane Bulk Cut Facility 70 is fed by stream 83 which is split from production gas stream 80 through utilizing a control valve at 81. The flow split at 81 is included in order to allow a portion of gas 82 to directly feed plant 60 just as it did before the plant 60 was upgraded. As the flows from the Bulk Cut Gathering System 50 increase, stream 82 would reduce in volume until stream 82 reaches zero volume. The objective is to keep plant 60 loaded at all times.

In the event that the plant 60 is not fully loaded, it may not be necessary to install the Membrane Bulk Cut Facility 70 nor install the equipment represented by streams 83, Enriched Heavy Hydrocarbon Stream 84, Enriched Heavy Hydrocarbon Stream 86, and Enriched Carbon Dioxide Stream 88. Instead, stream 82 would become the total flow from the wells represented by reference number 78.

Membrane Bulk Cut Facility 70 would function much as facilities 20 and 40 but since it would be located in close proximity to plant 60 the Enriched Carbon Dioxide Stream 88 would be sent to existing compression at the plant 60 for return to the field and the Enriched Heavy Hydrocarbon Stream 84 and Enriched Light Hydrocarbon Stream 86 would enter plant 60 without further compression. If gas compression for the Enriched Carbon Dioxide Stream equipment is not available at the plant 60 then gas compression equipment would be installed at Membrane Bulk Cut Facility 70.

### General Operation Description

The first step at the Membrane Bulk Cut Facility is to pretreat, as necessary, the production gas stream coming out of individual wells to bring the production gas stream to an operating pressure and operating temperature suitable for the effective operation of the reverse osmosis membranes which separate the production gas stream as described above. The pretreatment also includes removing any water that might condense, heavy hydrocarbons (the most important components to remove are C6+ and aromatics), and any remaining particulate matter from the production gas stream. Once pretreated the gas stream is fed to the reverse osmosis membrane units which split the gas stream into the Enriched Carbon Dioxide Stream, which is the permeate stream, and the Enriched Light Hydrocarbon Stream, which is the non-permeate stream. The non-permeate Enriched Light Hydrocarbon Stream may be entirely single phase gas but may instead be a two phase consisting principally of a gas phase with some condensed liquids as well. Because the pretreatment creates the Enriched Heavy Hydrocarbon Stream there are thus three total streams. For a simulation with 90% inlet carbon dioxide, the Enriched Carbon Dioxide Stream is 84% of the total, the non-permeate Enriched Light Hydrocarbon Stream is 14% of the total and the pretreat liquid Enriched Heavy Hydrocarbon Stream is 2% of the total. When combined these last two streams are called the Enriched Hydrocarbon Stream.

The Enriched Carbon Dioxide Stream is compressed to a field reinjection pressure and returned to the formation through an Enriched Carbon Dioxide Distribution and Injection system.

It is anticipated that the Membrane Bulk Cut Facility would be located at or near the reservoirs which produce Carbon Dioxide Flooded EOR oil thereby minimizing the length and cost of a transport pipeline system. Shorter transport pipeline lengths decrease the investment needed in transport pipeline systems and minimizes the pressure drop between the ends of the transport pipeline. In this sense a Membrane Bulk Cut Facility resembles a prior art carbon dioxide reinjection system without any processing of the carbon dioxide gas and without obtaining any value from the hydrocarbons coming out of an oil well. It has been shown that many mature Carbon Dioxide Flooded EOR oilfields have about 90% or more carbon dioxide in the production gas. The reinjection gas volume could still be about 84% of the volume of the prior art type of carbon dioxide gas reinjection only.

By the action of the reverse osmosis membranes the bulk of the hydrocarbons and nitrogen gas are removed from the production gas stream. The membranes may remove about 72% of the methane to be recovered rather than the Enriched Carbon Dioxide Stream which is reinjected. This generates value directly but also removing methane serves to keep the minimum miscibility of the reservoir from rising. The same reservoir issues are associated with nitrogen. Because the reverse osmosis membranes may also remove about 75% of the nitrogen, the use of reverse osmosis membranes indirectly adds value when the production gas stream has a high content of nitrogen. In those cases where the production gas stream includes a high content of nitrogen (and methane), prior art full stream reinjection only or the use of a prior art processing plant that recovers only natural gas liquids, the minimum miscibility of the oil in the reservoirs would rise until it may impair the recovery of oil from the oilfield. The use of reverse osmosis membranes at a nearby Membrane Bulk Cut Facility would substantially mitigate such problems.

The Enriched Heavy Hydrocarbon Stream and the Enriched Light Hydrocarbon Stream exiting the Membrane Bulk Cut Facility are transported to the Bulk Cut Gathering System. The Enriched Heavy Hydrocarbon Stream produced by the pretreatment of the production gas stream or from the reverse osmosis membrane separation are pumped and co-mingled with the compressed and cooled gas and transported to the Bulk Cut Gathering System. The pressure at the Bulk Cut Gathering System should be at a level which maintains the Enriched Hydrocarbon Stream in a dense phase. A dense phase will be understood to be either a fluid above the cricondenbar or a liquid; for example, a pipeline pressure from about 1500 psi to about 2000 psi. Such dense phase pressure is slightly lower than is found in most carbon dioxide gas source pipelines and in field reinjection pipelines. If the dense phase pipeline capacity needs to be increased, a pump station can be readily installed because this is a dense phase operation.

Compared to the options of gathering the complete stream of production gas from a Carbon Dioxide Flooded EOR oilfield, the reduction of gas volume received at the Bulk Cut Gathering System will be significant. A computer simulation had indicated that the Enriched Hydrocarbon Stream can be reasonably reduced to about 16% of the original volume of the production gas stream due to the use of reverse osmosis membranes. In addition, dense phase fluid densities can be close to four times greater than the low pressure gathering that has traditionally been utilized for prior art gathering of the production gas in a Carbon Dioxide gas flooded EOR oilfield.

The combination of the use of reverse osmosis membranes and the increase in density of the Enriched Hydrocarbon Stream can reduce the volume of the gas transported to the Bulk Cut Gathering System by 96% or more. Such dramatic reduction in gas volume results in the use of much smaller and less expensive gas transport pipeline systems. As the gas flowing to the Bulk Cut Gathering System is in a single dense phase there are no pressure surges or liquid slugs such as those often associated with multiphase gas pipelines. As previously indicated, no slug catchers are needed downstream at the inlet to the Bulk Cut Processing Plant and no pigging within the pipeline is needed to manage the liquid slugs.

In dense phase transport, a back pressure maintenance valve will be installed near the Bulk Cut Processing Plant to assure that the back pressure is maintained in the pipeline between the Bulk Cut Gathering System and the Bulk Cut Processing Plant to maintain the dense phase of the transported Enriched Hydrocarbon Stream. This maintenance of the dense phase of the transported Enriched Hydrocarbon Stream provides the added benefit that dropping the pressure at the back pressure maintenance valve will drop the temperature at the fluid inlet near the Bulk Cut Processing Plant to about zero degrees Fahrenheit. This temperature drop at the back pressure maintenance valve reduces the need for refrigeration of the gas at the Bulk Cut Processing Plant.

While the Bulk Processing Plant may be complex in terms of the equipment, the equipment need for the Membrane Bulk Cut Facility in the system and method of the present invention is much less complex. For example, a single operating company will typically have the technical capability to operate both the compression and dehydration portions of the prior art full production stream reinjection facility. The same technical skill set is needed to operate the Membrane Bulk Cut Facility as the prior art compression and dehydration equipment.

The reverse osmosis membrane units themselves have no moving parts nor do the pretreat filters have any moving parts. The temperature adjustment section of the Membrane Bulk Cut Facility will have a refrigeration compressor. As will be understood by those of ordinary skill in the art, this refrigeration compressor has a relatively simple design as the refrigeration operating temperature will be about 35 degrees Fahrenheit.

According to the system and method of the present invention there will be more equipment located at the Membrane Bulk Cut Facility than compared to the equipment located near the well when a prior art full production gas stream is reinjected into the underground formation. However, the compression, dehydration, refrigeration and membrane gas separation equipment will be of standard design like the equipment typically used for Carbon Dioxide Flooded EOR oilfield service. No unusual or specially designed equipment is needed.

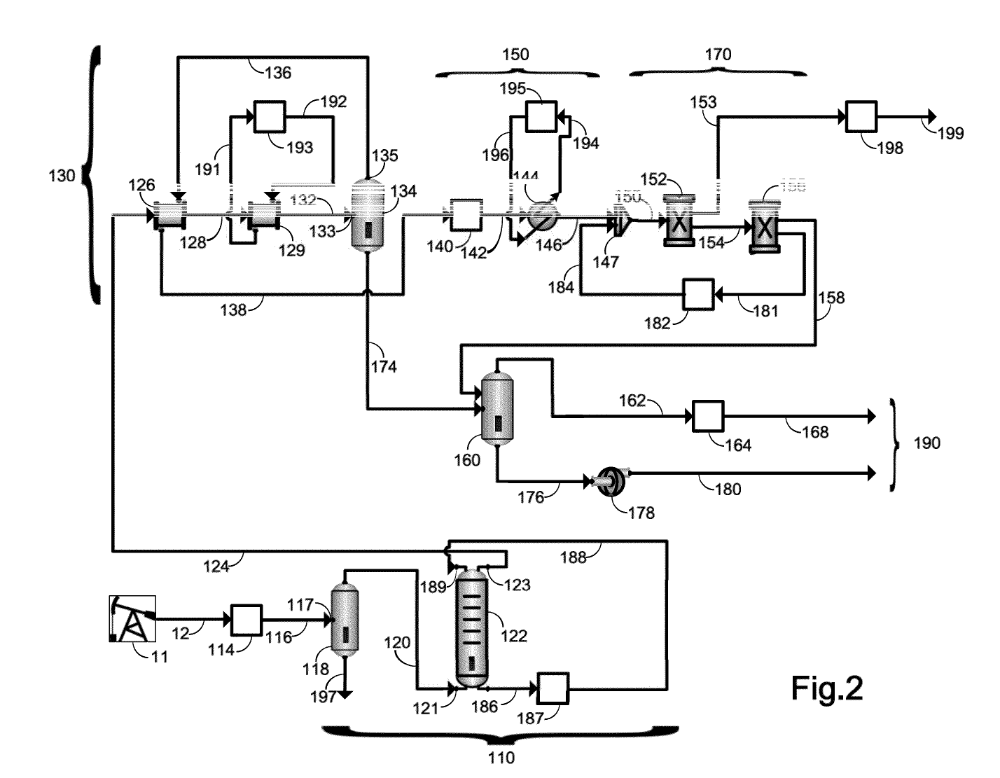

A still better understanding of the operation of the preferred embodiment of the present invention may be had by reference to FIG. 2 which illustrates the pretreating and separation of the production gas stream coming out an individual oil well.

In the Membrane Bulk Cut Facility shown in FIG. 2 there are seven distinct sections or major equipment: an inlet compressor 114, a dehydration or water removal section 110, a temperature adjustment section for chilling 130, a filtration or particulate removal and temperature adjustment reheat section 150, a reverse osmosis membrane section 170, Enriched Carbon Dioxide compression 198, and pumping section to achieve dense phase for the Enriched Heavy Hydrocarbon Stream and compression to achieve dense phase for the Enriched Light Hydrocarbon Stream to be gathered into the Bulk Cut Gathering System 190.

Those of ordinary skill in the art will understand that other combinations of equipment may be utilized to accomplish the pretreatment functions of removing water that may condense, heavy hydrocarbons (the most important components to remove are C6+ and aromatics), and any remaining particulate matter from the production gas stream. Different equipment configurations may be used depending on the particular composition of the fluids coming out an individual well 11. Different membrane configurations are also possible depending on the composition of gas to be processed at the Bulk Cut Processing Plant.

For the production gas stream 12 accompanying the liquid stream at an individual oil well 11, the production gas stream 12 enters compressor package 114 including scrubbers and after-coolers to bring it to a pressure suitable, typically about 500 psig, for gas pretreatment and reverse osmosis membrane separation. Compressor package 114 is a one or two stage reciprocating gas compressor and can be omitted for some fields where the field gathering pressure is sufficient without compression. Each stage of the gas compressor package 114 includes an inlet separator and an after-cooler. A centrifugal gas compressor may also be used in place of a reciprocating compressor.

Once the production gas stream 12 has been brought to the desired pressure by the gas compressor package 114 the compressed production gas stream 116 exiting the compressor package 114 passes through an inlet 117 to enter a separator 118 to remove any condensed liquid. The condensed liquid 197 exiting the separator 118 would generally be a small fraction of the compressed production gas 116 passing through the inlet 117. It is anticipated that the condensed liquid 197 will be primarily water which is returned to the water stream exiting the oil well 11. The water saturated outlet stream 120 flows onto a dehydration unit for further removal of water. In the preferred embodiment a TEG contactor dehydration system 122 is used; however any type of dehydration system known to those of ordinary skill in the art may be used. The water saturated stream 120 flows through the inlet 121 to the TEG contactor unit 122 and once treated exits at outlet 123. Once the amount of water in the dehydrated gas stream is reduced to a suitable level, the dehydrated gas stream 124 leaves the TEG contactor 122 for the next stage in the pretreatment of the production gas stream.

A better understanding of the TEG dehydration system may be had from the following description. Stream 188 is the substantially lean TEG that enters the TEG contactor unit 122 at inlet 189. This substantially lean TEG 188 enters the TEG contactor unit 122 and makes intimate contact with the water saturated stream 120 in a countercurrent fashion utilizing trays or packing. The water laden glycol stream 186 flows to the TEG regenerator system 187 which lowers the pressure of the TEG stream as close as possible to atmospheric pressure and applies sufficient heat to boil off the water absorbed in the TEG contactor unit 122. The pressure of the regenerated lean glycol stream is then increased at a pump, which is included in the TEG regenerator system 187, to a level where it can be returned to the TEG contactor 122 as part of the lean TEG stream 188.

The dehydrated stream 124 flows on to the next pretreatment section, the refrigeration or temperature adjustment section 130. The dehydrated production gas stream 124 enters back heat exchanger 126 which reduces the temperature of the dehydrated production gas stream 124. Exiting the back heat exchanger 126 is a pre-chilled gas stream 128 that is temperature adjusted by chilling in a heat exchanger 129 to a temperature suitable for removal of most of the heaviest hydrocarbons. The outlet stream 132 from the heat exchanger 129 is sent to the inlet 133 of the cold separator 134. The chilled gas stream 136 leaving the outlet of the cold separator 134 is then conveyed to the back heat exchanger 126 to raise its temperature. This reduces both the refrigeration required needed and returns the gas to a preferred temperature for further gas conditioning.

The refrigeration system passing through heat exchanger 129 is identified by streams 191 and 192 together with the refrigeration unit 193. The warm stream 191 exiting the heat exchanger 129 and the colder stream 192 flowing to the heat exchanger 129 may be one of several different fluids such as chilled glycol and water, ammonia, propane or other fluids. The refrigeration accomplished by refrigeration unit 193 may be done in a variety of different ways using a compressor as a means for removing heat energy from the refrigerant.

Stream 138 coming out of the back heat exchanger 126 now flows into the filtration section 150 of the Membrane Bulk Cut Facility. Specifically, stream 138 flows into filtration unit 140. The filters contained in the filtration unit 140 include a coalescing filter followed by a guard bed which is followed by a polishing bed. The filtration unit 140 removes any remaining liquid and particulate matter.

Post-filtration stream 142 may be at a lower temperature than desired. Accordingly, part of stream 142 may be sent through a heat exchanger for temperature adjustment 144, if needed, as the final pretreatment prior to passing the post-filtration gas stream 144 to the reverse osmosis separation membranes. Those of ordinary skill in the art understand that the temperature of the post-filtration gas stream 142 may be raised in a variety of different ways. For example, utilizing hot gas from one of the compressor stages will provide the needed heat at little or no cost. As shown, liquid 194 passing through heat exchanger 144 will be heated by a residue gas fired line heater 195 with the heated liquid 196 being pumped back to the heat exchanger 144.

Note that the conditioning of production gas stream 12, the dehydrated gas stream 124, the pre-chilled gas stream 128, the post heat exchanger stream 132, the chilled gas stream 136, the chilled stream 138 from the back heat exchanger 126 and the post-filtration stream 142 involve the use of equipment and procedures well known in the prior art. This conditioning is performed to assure that the pretreated gas stream 146 exiting the heat exchanger 144 that enters the membrane section 170 is free of liquid water, heavy hydrocarbons (the most important components to remove are C6+ and aromatics), is free of particulate matter, and is at the correct temperature for reverse osmosis membrane separation.

Pretreated stream 146 mixes with a recycle stream 184 at tee joint 147 to become a combined stream 151 which enters the first of two reverse osmosis membrane units 152 and 156. At the outlet of the first reverse osmosis membrane unit 152, the combined stream 151 exits as permeate Enriched Carbon Dioxide Stream 153 and a non-permeate hydrocarbon rich stream 154. Non-permeate hydrocarbon rich stream 154 flows to the second reverse osmosis membrane unit 156.

The non-permeate hydrocarbon reach stream 154 is split into a carbon dioxide permeate stream 181 and a non-permeate Enriched Light Hydrocarbon Stream 158. This configuration removes a high percentage of the carbon dioxide (about 90+% of carbon dioxide between streams 158 and 181) while keeping recycle horsepower at a suitable level.

The pressure of the permeate carbon dioxide stream 181 is increased at compressor 182 which would typically be a one or two stage compressor with scrubbers and after-coolers and mixed with pretreated gas flow 146 at tee joint 147. Those skilled in the art recognize that there are many suitable ways of accomplishing the separation of carbon dioxide using reverse osmosis membranes other than the preferred embodiment of the Membrane Bulk Cut Facility shown in FIG. 2.

Regardless of the many different ways the Membrane Bulk Cut Facility may be configured, the Membrane Bulk Cut Facility is intended to create a permeate Enriched Carbon Dioxide Stream 153 and a non-permeate Enriched Light Hydrocarbon Stream 158 ready for transport to a Bulk Cut Gathering System accomplished by compression and pumping of section 190. Non-permeate Enriched Light Hydrocarbon Stream 158 flows to separator 160 to capture any liquids formed from membrane unit 156. Enriched Heavy Hydrocarbon Stream 174 from cold separator 134 also flows to separator 160. Enriched Heavy Hydrocarbon Stream 174 and the non-permeate Enriched Light Hydrocarbon Stream 158 are combined in separator 160. The Enriched Heavy Hydrocarbon Stream 176 exiting separator 160 flows to pump 178. Pump 178 pumps the liquids to a pressure high enough to enter a dense phase pipeline 180 after leaving the Membrane Bulk Cut Facility. The Enriched Light Hydrocarbon Stream 162 leaving separator 160 flows to a one or two stage compressor with scrubber and after-cooler 164 which compresses and cools the discharge gas 168 which exits the Membrane Bulk Cut Facility. As this is a dense stream, the pressure leaving the compressor 164 may be as high as about 2000 psig.

The permeate Enriched Carbon Dioxide Stream 153 exiting the membrane section 170 will be at a pressure which is significantly lower than the pressure at the input to the membrane section 170, about 135 psia (note: for different membrane configurations this pressure may be significantly different than this value). This Enriched Carbon Dioxide Stream 153 flows to a compressor 198 including scrubbers and after-coolers for compression to a pressure sufficient for reinjection back into the reservoir via stream 199, such pressures being about 2000 psi. Stream 199 will feed the Carbon Dioxide Distribution and Injection System. Compressor 198 is typically three-stages of reciprocating compression in the preferred embodiment. Those of ordinary skill in the art will understand that a centrifugal compression may be used as a substitute for the reciprocating compressor 198.

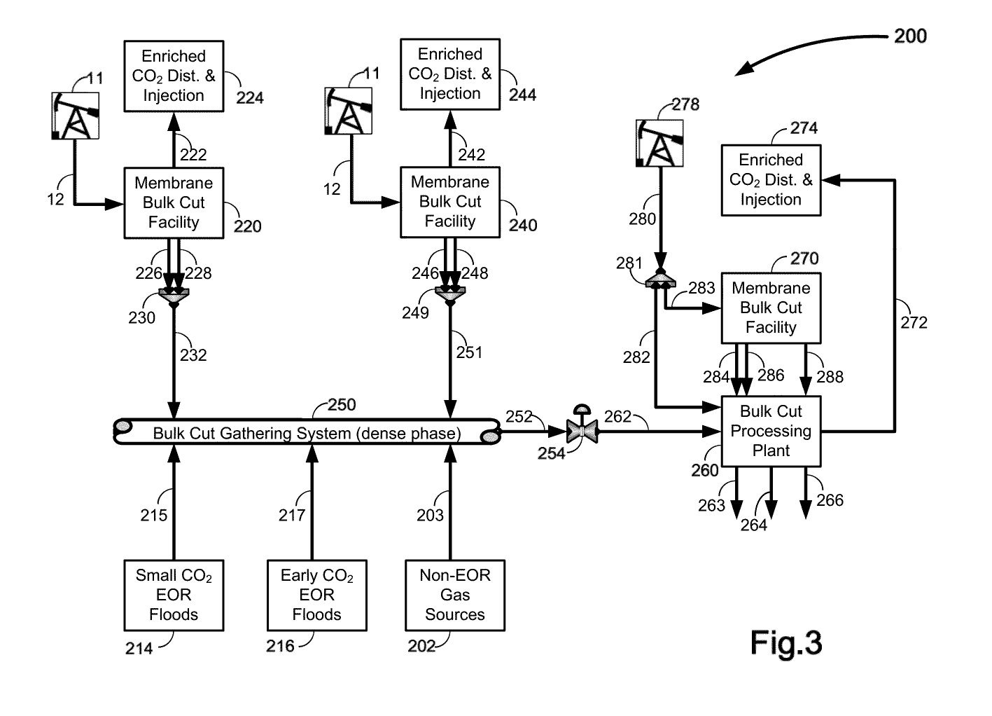

Shown in FIG. 3 is a second embodiment of the system and method 200 of the present invention. System and method 200 are similar to the preferred embodiment 10 shown in FIG. 1. Accordingly, the reference numbers used in FIG. 3 are preceded by the number 2 in the hundreds place. The difference in embodiment 200 is that input 203 to the Bulk Cut Gathering System 250 is also obtained from non-Carbon Dioxide Flooded EOR sources 202. This input 203 from non-Carbon Dioxide Flooded EOR sources 202 joins the gas flow 215 from small Carbon Dioxide Flooded EOR oilfields 214, the input 217 from the early stage Carbon Dioxide Flooded EOR oilfields 216 and the outputs 232, 251 from one or more Membrane Bulk Cut Facilities 220, 240 in the output stream 252 transported to the Bulk Cut Processing Plant 260. As the impact of non-Carbon Dioxide Flooded EOR sources 202 will be small and can be mitigated through operational changes to Membrane Bulk Cut Facilities the term Enriched Hydrocarbon Stream will also include this source of gas. The importance of embodiment 200 is that the disclosed system and method is not restricted to use with just Carbon Dioxide Flooded EOR oilfields but may also enhance the recovery of value from non-Carbon Dioxide Flooded EOR oilfields.

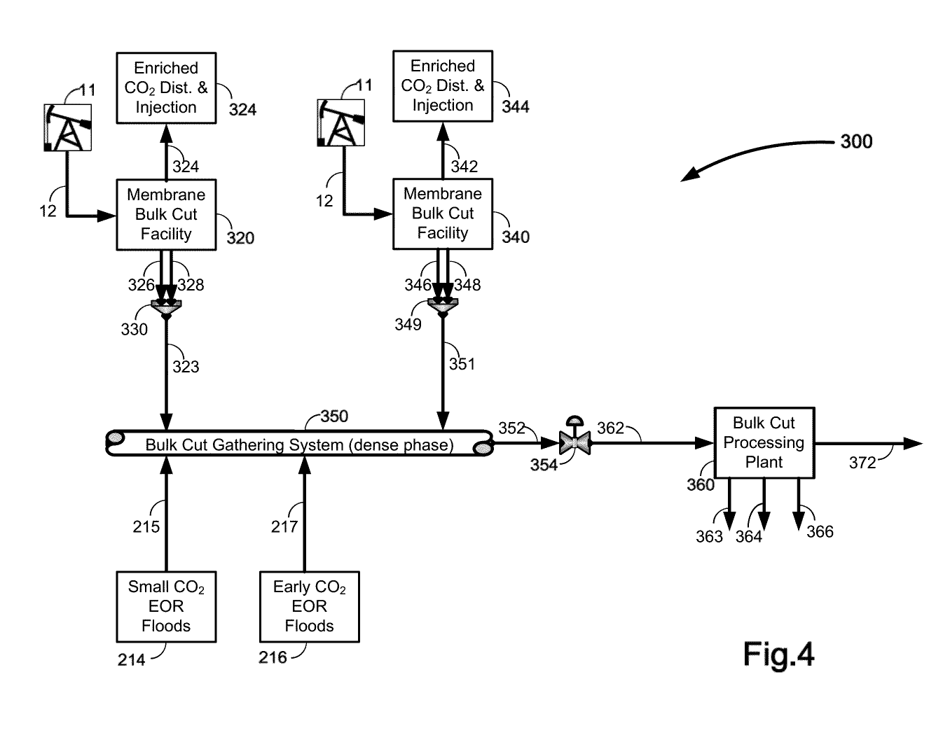

Shown in FIG. 4 is a stand-alone third embodiment 300 of the system and method of the present invention The reference numbers used in FIG. 4 are the same as the reference numbers used in FIG. 1 but for the number 3 in the hundreds place. The third embodiment 300 described in FIG. 4 will be suitable for use and operation by a single oil well, oil reservoir or oilfield operator. Note that the Membrane Bulk Cut Facility near the Bulk Cut Processing Plant 60 shown in FIG. 1 has not been included as much of the Enriched Carbon Dioxide gas is returned to the underground formation by the two Membrane Bulk Cut Facilities 320 and 340. The Bulk Cut Processing Plant 360 is a stand-alone plant not connected to a Carbon Dioxide flood EOR oilfield. The carbon dioxide stream 372 is to be sold for others for injection into a Carbon Dioxide flood EOR oilfield.

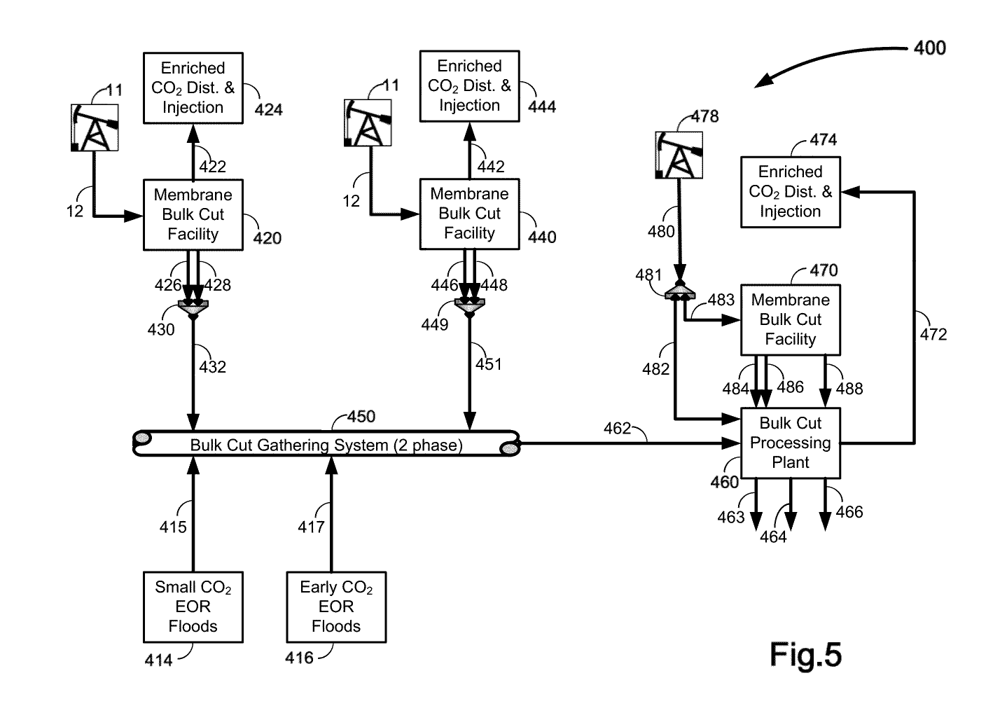

Shown in FIG. 5 is a fourth embodiment 400 of the system and method of the present invention. The general operation of the fourth embodiment 400 is the same as shown in the preferred embodiment 10 in FIG. 1. The reference numbers used in FIG. 5 are the same as used in FIG. 1 but for the number 4 in the hundreds place. In this fourth embodiment the fluids transported to the Bulk Cut Processing Plant 460 are not transported in a dense phase. Rather, the fluids are transported in two phases at low pressure, typically from 400 psig to 740 psig. Accordingly, a back pressure maintenance valve is not needed in the transport pipeline between the Bulk Cut Gathering System 450 and the Bulk Cut Processing Plant 460.

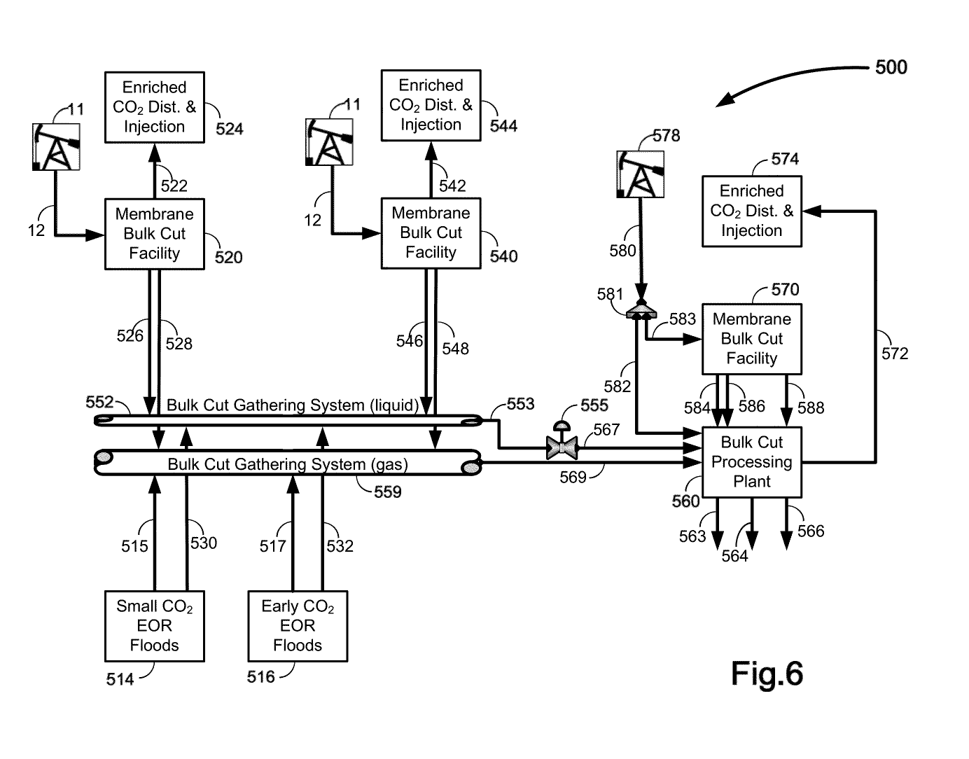

Shown in FIG. 6 is a fifth alternate embodiment 500 similar in construction and operation to the fourth embodiment 400 shown in FIG. 5. As with the description of the prior alternate embodiments, the reference numbers are the same as shown in FIG. 1 but for the number 5 in the hundreds place. The fifth embodiment 500 is also a low pressure embodiment where the back pressure maintenance valve just before the Bulk Cut Processing Plant 560 that would have held back pressure on the gas Bulk Cut Gas Gathering System 569 has been eliminated. Herein the liquids and gases are transported to a liquid Bulk Cut Gathering System 552 and a gas Bulk Cut Gathering System 559. The Enriched Light Hydrocarbon Stream 526 and 546 enter the liquid Bulk Cut Gathering System 552. For Small carbon dioxide EOR floods 514 and early stage carbon dioxide floods 516 refrigeration, of a design well understood by those of ordinary skill in the art, would be utilized to remove liquids that otherwise condense during gathering and move those liquids in streams 530 and 532 to the liquid Bulk Cut Gathering System 552. The liquid Bulk Cut Gathering System 552 liquid is transported in a liquid pipeline 553 to liquid back pressure maintenance valve 555 and then through pipe 567 to the Bulk Cut Processing Plant 560. The back pressure maintenance valve 555 holds sufficient pressure on the liquid Bulk Cut Gathering System 552 that it remains liquid with no gas breakout. The gas Bulk Cut Gathering System 559 transports the gas to a pipeline 569 to the Bulk Cut Processing Plant 560. The use of the fifth embodiment 500 will reduce or eliminate liquid slugs while operating the gas Bulk Cut Gathering System 559 at the same low pressure as the gathering pressure in embodiment 400.

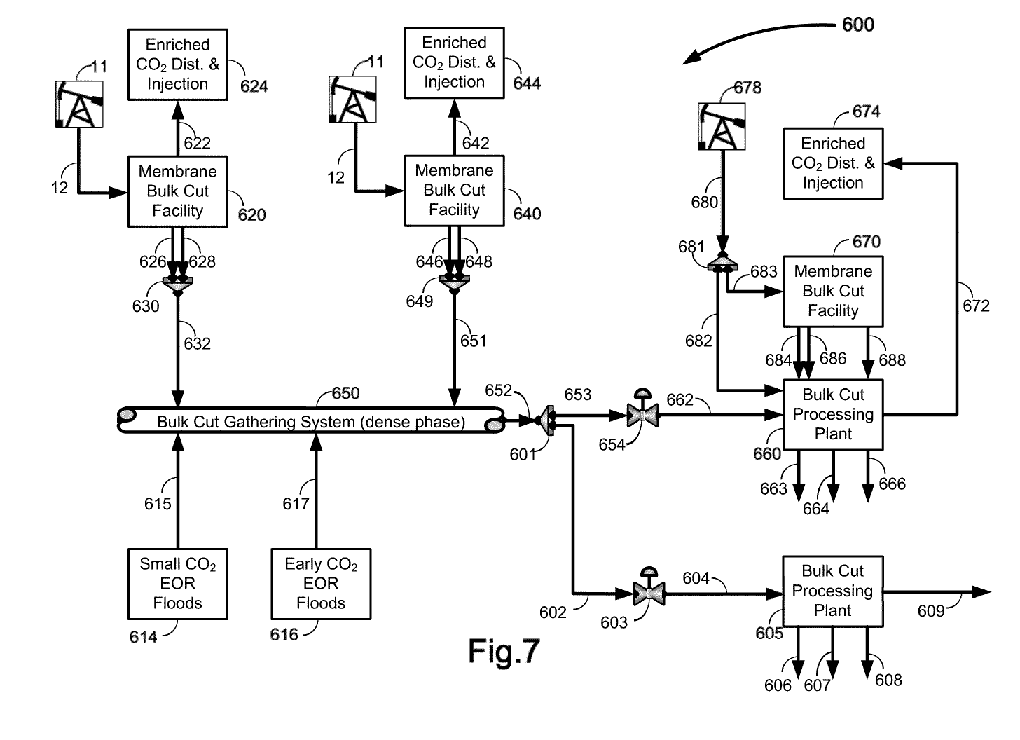

Shown in FIG. 7 is a sixth embodiment 600 of the system and method of present invention. The construction and operation of the sixth embodiment 600 is generally the same as the preferred embodiment 10 shown in FIG. 1. Accordingly, the reference numbers used in FIG. 7 are similar to those used in FIG. 1 but for the use of the number 6 in the hundreds place. In the sixth embodiment 600 a second Bulk Cut Processing Plant 606 as a second plant to process the fluids from the Bulk Cut Gathering System 650. The components and operation of the Bulk Cut Processing Plant 606 are similar in nature to the stand-alone Bulk Cut Processing Plant 360 of FIG. 4. The importance of this embodiment is that more than one Bulk Processing Plant may be utilized to chemically transform the fluids from the Bulk Cut Gathering System 650 into valuable products. Those of ordinary skill in the art will recognize that the additional Bulk Cut Processing Plant 606 could be connected to a Carbon Dioxide Flooded EOR oilfield much as Bulk Cut Processing Plant 660 is.

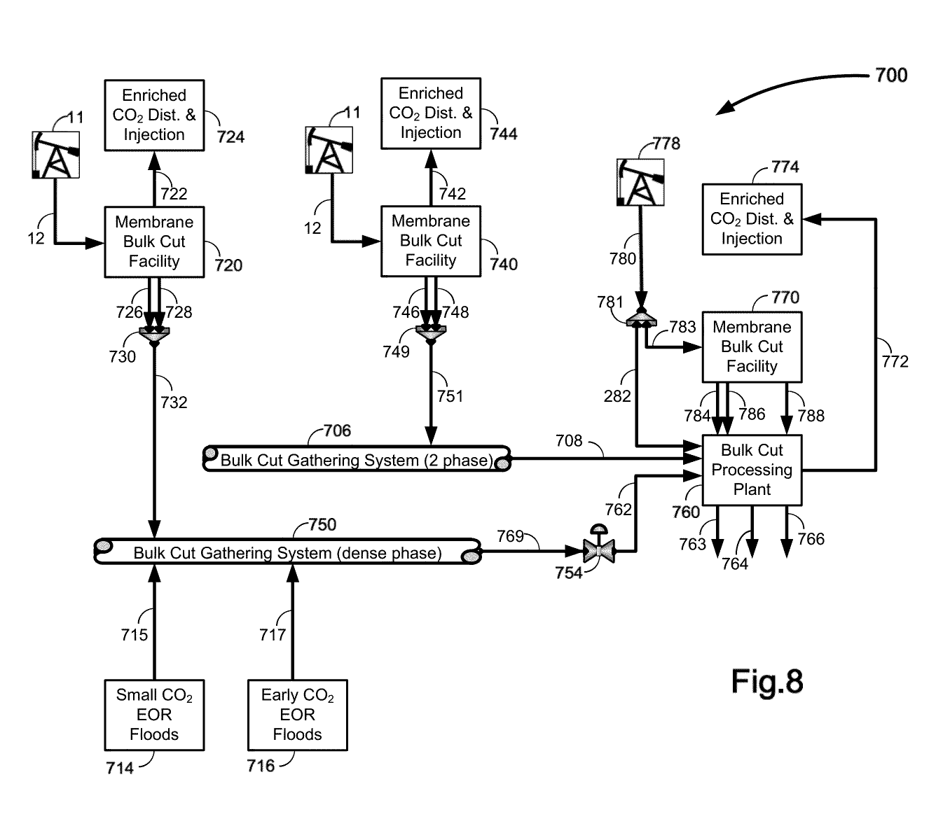

Shown in FIG. 8 is a seventh embodiment of the system and method 700 of the present invention. System and method 700 are similar to the preferred embodiment 10 shown in FIG. 1. Accordingly, the reference numbers used in FIG. 8 are preceded by the number 7 in the hundreds place. The difference in embodiment 700 is that input 751 to the Bulk Cut Gathering System 706 is entering a low pressure two phase gathering system, whereas all other inputs 732, 715, and 717 are entering the Bulk Cut Gathering System 750 which is operating in the dense phase at a much higher pressure. Bulk Cut Gathering System 706 is gathered in a low pressure two phase gas and liquid to the Bulk Cut Processing Plant 760. The construction and operation or Bulk Cut Gathering System 706 is similar to the fourth embodiment 400 shown in FIG. 5. Bulk Cut Gathering System 750 is gathered in the dense phase through 769 and only downstream of back pressure maintenance valve 754 is the pressure dropped to low pressure into the plant. The importance of embodiment 700 is that the disclosed system and method is not restricted to use only one form of gathering system. This may be of practical importance where a new dense phase pipeline is installed to Carbon Dioxide Flooded EOR oilfields in one direction from the Bulk Cut Processing Plant 760 and an existing line, that cannot be increased in pressure, is converted to gather gas from other Carbon Dioxide Flooded EOR oilfields in another direction from the Bulk Cut Processing Plant 760. Those of ordinary skill in the art will realize that any and all types of gathering systems disclosed in the various embodiments may be utilized as needed to gather gas to the Bulk Cut Processing Plant.

Those of ordinary skill in the art will understand that system and method of the present invention is environmentally friendly in that the emissions of carbon dioxide gas into the atmosphere are minimized. Carbon Dioxide Flooded EOR oilfields store carbon dioxide gas while causing the crude oil to come out of an underground reservoir through individual wells. To the extent that carbon dioxide gas is sourced from anthropogenic or man-made sources, Carbon Dioxide Flooded EOR oilfields effectively reduce carbon dioxide emission by sequestering the carbon dioxide gas deeply underground. It is the purpose of the system and method of the present invention to reduce the cost and enhance the quality of carbon dioxide floods in underground formation thereby making Carbon Dioxide Flooded EOR oilfields a more viable and longer lasting solution to enhance the production of oil from underground reservoirs.

Still further advantages of the system and method of the present invention over prior art systems will be readily understood by those of ordinary skill in the art, as follows.

Current processing costs in Carbon Dioxide Flooded EOR oilfields have proven to be prohibitively expensive so many operators of wells in Carbon Dioxide Flooded EOR oilfields forgo obtaining additional value from the recovery of hydrocarbons from the produced gas stream. The system and method of the present invention offers the ability to economically recover and obtain revenue, at the very least, from the natural gas liquids.

Removal of both nitrogen and methane by the Membrane Bulk Cut Facility from the reinjected Enriched Carbon Dioxide gas helps prevent the minimum miscibility pressure of the crude oil in the oilfield from increasing. This reduction in the increase of minimum miscibility pressure provides a benefit to the well operators located in Carbon Dioxide Flooded EOR oilfields.

The general configuration of the in-field Membrane Bulk Cut Facilities, the gathering of the Enriched Hydrocarbon Stream and the separation of processing facilities fits comfortably with the way in which field compression, gas gathering and processing is performed in non-Carbon Dioxide Flooded EOR oilfield operations. Although the fluids are handled much differently; that is, the majority of the carbon dioxide is reinjected locally and the Enriched Hydrocarbon Stream still contain carbon dioxide. Because the system and method of the present invention, the use of the system and method of the present invention lends itself to the use of familiar business models regarding compensating for the cost of the system and method of the present invention and returning value to the operators of individual oil wells. In addition, the use of existing contracts and operating approaches can be applied as indicated below.

The Membrane Bulk Cut Facilities have no greater complexity than that found in prior art gas compression systems. Accordingly, the Membrane Bulk Cut Facilities will require relatively little maintenance as a minimum of moving parts and sophisticated control systems is used.

The Bulk Cut Gathering System, at most, will operate much like prior art distribution systems.

The Bulk Cut Processing Plant will have the same level of complexity of prior art gas processing plants.

The system and method of the present invention minimizes the physical movement of molecules of carbon dioxide gas. The majority of the carbon dioxide gas in the production gas stream is reinjected back into the oilfield while the Enriched Hydrocarbon Stream being transported and gathered to a remote gas processing plant thereby minimizing the size of the transport pipeline system and thus its cost. Pipeline friction loss within the transport pipeline system is also reduced thereby reducing the amount of horsepower needed to move fluids through the pipeline and thus the operating cost. No return Enriched Carbon Dioxide gas transport pipeline is required; thereby further reducing the cost of the system and method of the present invention over prior art systems and methods.

The existence of Membrane Bulk Cut Facilities introduces the opportunity to better control the composition of the gas delivered to the Bulk Cut Gathering System and the downstream Bulk Cut Processing Plant. Such opportunity opens up a series of additional opportunities to optimize the installation and the operation of Membrane Bulk Cut Facilities. For example, as indicated above with regard to the third embodiment illustrated in FIG. 4, the use of a Membrane Bulk Cut Facility may not be required at a small Carbon Dioxide EOR flood. Instead, an existing Membrane Bulk Cut Facility at another Carbon Dioxide EOR flood at another oilfield may be provided with additional capacity by using more reverse osmosis membranes to generate an overall suitable Enriched Hydrocarbon gas feed to the Bulk Cut Processing Plant. In larger oilfields, reverse osmosis membrane installation could be delayed until the amount of carbon dioxide in the production gas increases, thereby delaying the timing of investment in the system and method of the present invention until the return in value to the well operators is maximized. Such type of compositional control of the components of a system and method for the gathering and processing of production gas is rarely available.

Moving dense phase gas between the Membrane Bulk Cut Facility to the Bulk Cut Gathering System and the Bulk Cut Processing Plant as shown in the preferred embodiment provides the following advantages.
The need for a slug catcher at the Bulk Cut Processing Plant is eliminated.
The size and cost of the transport pipeline system is reduced.

A back pressure maintenance valve is installed at the inlet to the Bulk Cut Processing Plant which creates useful refrigeration at the Bulk Cut Processing Plant. It has been shown that the horsepower refrigeration saved at the Bulk Cut Processing Plant will be greater than the horsepower required to raise the gas stream pressure from the outlet of the Membrane Bulk Cut Facility to dense phase pressure.

The system and method of the present invention enhances the heating value of the Enriched Hydrocarbon Stream which thereby increases the associated the revenue density (revenue per unit volume) of the Enriched Hydrocarbon Stream. It is anticipated that the value of the feed gas to the Bulk Cut Processing Plant can be increased by up to six times when compared to the processing of raw produced gas. The carbon dioxide gas is an undesired by product at the Bulk Cut Gathering System and the Bulk Cut Processing System. The upstream location of the Membrane Bulk Cut Facility improves the design, installation, and operation of all downstream equipment by eliminating the carbon dioxide gas.

Processing the Enriched Hydrocarbon Stream input to the Bulk Cut Processing Plant limits the need for product transport pipelines. Rather than transporting all products through one pipeline to the Bulk Cut Processing Plant to create multiple products generally delivered by multiple pipelines to final customers, use of the disclosed system and method can reduce the total number and length of transport pipelines required.

The advantages provided at the Bulk Cut Processing Plant are as follows.
The lower concentration of carbon dioxide gas is in the gas stream provided to the Bulk Cut Processing Plant enables the following.
Ethane recovery will be greater for distillation based carbon dioxide gas removal systems.

Flares will not require the use of added fuel at the Bulk Cut Processing Plant. Currently produced gas from mature Carbon Dioxide Flooded EOR oilfields typically has insufficient heating value to be flared without adding natural gas to the flare stream. Such need for additional natural gas has proven to be a challenge as it is difficult and costly to obtain the needed natural gas on an emergency basis. The Enriched Hydrocarbon Stream to the Bulk Cut Processing Plant contains sufficient heating value so that no addition of natural gas when flaring is needed.

A reduced flow rate to the Bulk Cut Processing Plant results in the following.
Smaller equipment including both vessels and distillation columns.
Smaller pumps and compressors require the use of less power.
Lower heating and cooling requirements reduce the amount of energy needed.

Existing gas processing plants may be retro-fitted for use in the system and method of present invention, as follows.
Bulk Cut Processing Plants can be made by modifying existing Carbon Dioxide Flooded EOR oilfield processing plants. The removal of the bulk of the carbon dioxide gas that enters an existing Carbon Dioxide EOR flooded oilfield is one of the biggest advantages. With the elimination of the bulk of the carbon dioxide and the hydrogen sulfide (if present) the Bulk Cut Processing Plant can accommodate much larger amounts of an Enriched Hydrocarbon Stream using the same equipment. For example, compression and inlet distillation columns need not be augmented. Sulfur recovery is not burdened as any hydrogen sulfide gas removed in roughly the same proportion as the carbon dioxide is removed. It is anticipated that it may be necessary in some installations to upgrade the residue gas and liquids recovery systems but upgrading the residue gas and liquids recovery systems are directly related to a revenue increase.
Existing non-Carbon Dioxide EOR flood processing plants are also desirable as new processing equipment can be placed upstream of existing gas processing plants at the non-Carbon Dioxide Flooded EOR oilfield processing plants to remove enough of the carbon dioxide gas to the current non-Carbon Dioxide Flooded EOR oilfield processing plant to operate more efficiently.

Those of ordinary skill in the art will understand that while the disclosed system and method of the present invention have been disclosed according to its preferred and other embodiments numerous combinations and arrangements of the disclosed system and method may be made without departing from disclosed invention. Such combinations and arrangements shall fall within the scope and meaning of the appended claims.

I claim:

1. A method for realizing added value from production gas streams exiting existing oil wells in a Carbon Dioxide Flooded EOR oilfield comprising:
pretreating the production gas stream for passage through one or more sets of gas separation membranes to separate said production gas stream into an Enriched Carbon Dioxide Stream and an Enriched Hydrocarbon Stream.
reinjecting the Enriched Carbon Dioxide Stream obtained from said one or more sets of gas separation membranes back into the Carbon Dioxide Flooded EOR oilfield;
transporting said Enriched Hydrocarbon Stream to a Bulk Cut Gathering System
transporting said Enriched Hydrocarbon Stream from the Bulk Cut Gathering System to one or more Bulk Cut Processing Plants for further separation and chemical transformation of said Enriched Hydrocarbon Stream into hydrocarbon products.

2. The method as defined in claim 1 wherein said Bulk Cut Processing Plant removes additional carbon dioxide from an Enriched Hydrocarbon Stream.

3. The method as defined in claim 1 wherein said Enriched Carbon Dioxide Stream is transported to one or more Enriched Carbon Dioxide Distribution and Injection Systems for reinjection of said Enriched Carbon Dioxide Stream back into said Carbon Dioxide Flooded EOR oilfield.

4. The method as defined in claim 1 wherein said Enriched Hydrocarbon Stream is transported from said one or more sets of gas separation membranes to said Bulk Cut Gathering System and then to said one or more Bulk Cut Processing Plants as a two phase liquid and gas stream.

5. The method as defined in claim 1 wherein said Enriched Hydrocarbon Stream is transported from said one or more sets of gas separation membranes to Bulk Cut Gathering System and then to said one or more Bulk Cut Processing Plants in a dense phase.

6. The method as defined in claim 1 wherein said Enriched Hydrocarbon Stream is further separated into liquid hydrocarbons and gaseous hydrocarbons for transport from said one or more sets of gas separation membranes to said Bulk Cut Gathering System and then transported to said Bulk Cut Processing Plants as liquid hydrocarbons and gaseous hydrocarbons.

7. The method as defined in claim 1 wherein a two phase Enriched Hydrocarbon Stream may be transported from one set of gas separation membranes to a Bulk Cut Gathering system and a Enriched Hydrocarbon Stream in a dense phase from another set of gas separation membranes may be transported to another type of Bulk Cut Gathering System.

8. The method as defined in claim 1 wherein said pretreatment of the production gas stream for passage through the gas separation membranes includes at least one of the following: dehydration, refrigeration, and filtration.

9. The method as defined in claim 1 wherein the Bulk Cut Processing Plants includes one or more gas separation membranes associated with the Bulk Cut Processing Plant for additional processing of production gas exiting oil wells in a carbon dioxide flooded EOR oilfield.

10. The method as defined in claim 1 wherein said Bulk Cut Gathering System also receives production gas from one or more of the following: a small Carbon Dioxide Flooded EOR oilfield, an early stage Carbon Dioxide Flooded EOR oilfield; and a non-Carbon Dioxide Flooded EOR oilfield for transport with said Enriched Hydrocarbon Stream to said Bulk Cut Processing Plant.

11. A system for realizing added value from a production gas stream in a Carbon Dioxide EOR oilfield comprising:
a Membrane Bulk Cut Facility to separate the production gas stream into an Enriched Carbon Dioxide Stream and an Enriched Hydrocarbon Stream;
a Carbon Dioxide Distribution and Injection System for reinjecting said Enriched Carbon Dioxide Stream from said Membrane Bulk Cut Facility back into Carbon Dioxide Flooded EOR oilfield;
a Bulk Cut Gathering System for receiving said Enriched Hydrocarbon Stream from said Membrane Bulk Cut Facility;
a Bulk Cut Processing Plant for receiving an Enriched Hydrocarbon Stream from said Bulk Cut Gathering System for separation and chemical transformation of the Enriched Hydrocarbon Stream into hydrocarbon products.

12. The system as defined in claim 11 wherein said Bulk Cut Processing Plant removes additional carbon dioxide from said Enriched Hydrocarbon Stream.

13. The system as defined in claim 11 wherein said Membrane Bulk Cut Facility pretreats said production gas before separation into an Enriched Carbon Dioxide Stream and an Enriched Hydrocarbon Stream.

14. The system as defined in claim 12 wherein the treatment of the production gas stream in said Membrane Bulk Cut Facility includes at least one of the following: dehydration, temperature adjustment, pressure adjustment and filtration.

15. The system as defined in claim 11 wherein said Enriched Hydrocarbon Stream contains both liquids and gases.

16. The system as defined in claim 15 wherein said Enriched Hydrocarbon Stream is transported from said Membrane Bulk Cut Facility to said Bulk Cut Gathering System and then to said Bulk Cut Processing Plant as a two phase liquid and gas stream.

17. The system as defined in claim 11 wherein said Enriched Hydrocarbon Stream is transported from said Membrane Bulk Cut Facility to said Bulk Cut Gathering System and then to said Bulk Cut Processing Plant in a dense phase.

18. The system as defined in claim 11 wherein said Enriched Hydrocarbon Stream is further separated into liquid hydrocarbons and gaseous hydrocarbons for transport from said Membrane Bulk Cut Facility to said Bulk Cut Gathering System and then to said Bulk Cut Processing Plant as liquid hydrocarbons and gaseous hydrocarbons.

19. The system as defined in claim 11 wherein a two phase Enriched Hydrocarbon Stream may be transported from said Membrane Bulk Cut Facility to a Bulk Cut Gathering System and a Enriched Hydrocarbon Stream in a dense phase from another Membrane Bulk Cut Facility maybe be transported to another Bulk Cut Gathering Facility.

20. The system as defined in claim 11 wherein said Bulk Cut Gathering System also receives production gas from one or more of the following: a small Carbon Dioxide Flooded EOR oilfield, and early stage Carbon Dioxide Flooded EOR oilfield, and a non-Carbon Dioxide Flooded EOR oilfield for transport with said Enriched Hydrocarbon Stream to said Bulk Cut Processing Plant.
